(19) United States
(12) Patent Application Publication
(10) Pub. No.: US 2014/0044149 A1
(43) Pub. Date: Feb. 13, 2014

(54) VEHICLE AMBIENT TEMPERATURE ESTIMATION SYSTEM

(71) Applicant: Kenji David Matsuura, Marysville, OH (US)

(72) Inventor: Kenji David Matsuura, Marysville, OH (US)

(73) Assignee: HONDA MOTOR CO., LTD., Tokyo (JP)

(21) Appl. No.: 13/571,988

(22) Filed: Aug. 10, 2012

(51) Int. Cl. G01K 13/00

(52) U.S. Cl. 374/145; 374/E13.001

(57) ABSTRACT

Ambient temperature is determined using a vehicle-implemented system based on an estimated ambient temperature determined in view of a radiator fluid temperature profile. During periods of radiator fan operation, radiator fluid temperature is measured and logged to create the radiator fluid temperature profile. A best-fit polynomial is fitted to the radiator fluid temperature profile, and a coefficient from the best-fit polynomial is used to reference a best-fit equation to ambient temperature relation. The relation is predetermined for the particular vehicle configuration, and the ambient temperature is estimated based on the coefficient from the fitted best-fit polynomial.

### BACKGROUND

The present disclosure generally relates to a system and method for ambient temperature estimation and determination, and more particularly relates to a system and method for estimating and determining ambient temperature based on vehicle radiator fan operation and a radiator fluid temperature profile.

Vehicle electronic control units (“ECUs”) are provided to control various vehicle systems. Several of the controlled vehicle systems may operate, at least in part, based on an ambient temperature. To provide an ambient temperature value for those vehicle systems, a vehicle ECU may include one or more temperature sensors configured to measure a temperature of intake air flow within a vehicle air intake. The temperature reading is then provided to the ECU, which controls ambient-temperature-dependant vehicle systems in view of the measured ambient temperature.

Ambient temperature measurement using temperature sensors in the vehicle's air intake may provide accurate ambient temperature values while the vehicle is in motion. However, when the vehicle is stopped while the engine is running (i.e., the vehicle is in an “idle” condition), the air intake temperature sensors may become heat soaked as the air flow through the air intake diminishes and/or fully stops and the standing air within the air intake is heated by the engine. As such, ambient temperature measurement using air intake temperature sensors may be inaccurate while the vehicle is in the idle condition.

### SUMMARY

According to one aspect, a vehicle-implemented method for estimating an ambient temperature comprises creating a radiator fluid temperature profile for periods of radiator fan operation and estimating the ambient temperature based on the created radiator fluid temperature profile. According to another aspect, a vehicle-implemented method for determining an ambient temperature comprises determining whether a vehicle is in an idle condition, setting the ambient temperature as a sensed ambient temperature from temperature sensors provided in a vehicle air intake when the vehicle is not in the idle condition, and setting the ambient temperature as an estimated ambient temperature estimated based on a radiator fluid temperature profile when the vehicle is in the idle condition.

According to still another aspect, a vehicular ambient temperature determination system comprises an ambient temperature estimation module configured to create a radiator fluid temperature profile based on sensed values of radiator fluid temperature during periods of radiator fan operation and to estimate an ambient temperature based on the radiator fluid temperature profile. According to yet another aspect, a vehicle electronic control unit comprises an ambient temperature estimation module configured to create a radiator fluid temperature profile based on sensed values of radiator fluid temperature during periods of radiator fan operation and to estimate an ambient temperature based on the radiator fluid temperature profile.

### BRIEF DESCRIPTION OF THE DRAWINGS

FIG. 1A is a block-schematic illustrating a vehicle ECU and vehicle components related to ambient temperature determination.

FIG. 1B is a block-schematic illustrating an ambient temperature estimation module.

FIG. 2 is a flow-chart illustrating a method for determining ambient temperature.

FIG. 3 is a flow-chart illustrating a method for estimating ambient temperature.

FIG. 4 is a graph illustrating an exemplary radiator fluid temperature profile.

FIG. 5 is a graph illustrating an exemplary best-fit equation to ambient temperature relation.

### DETAILED DESCRIPTION

The description and drawings herein are merely illustrative and various modifications and changes can be made in the structures disclosed without departing from what is defined in the appended claims. All references to direction and position, unless otherwise indicated, refer to the orientation of the structures and components illustrated in the drawings and should not be construed as limiting the claims appended hereto. Like numbers refer to like parts throughout the several views.

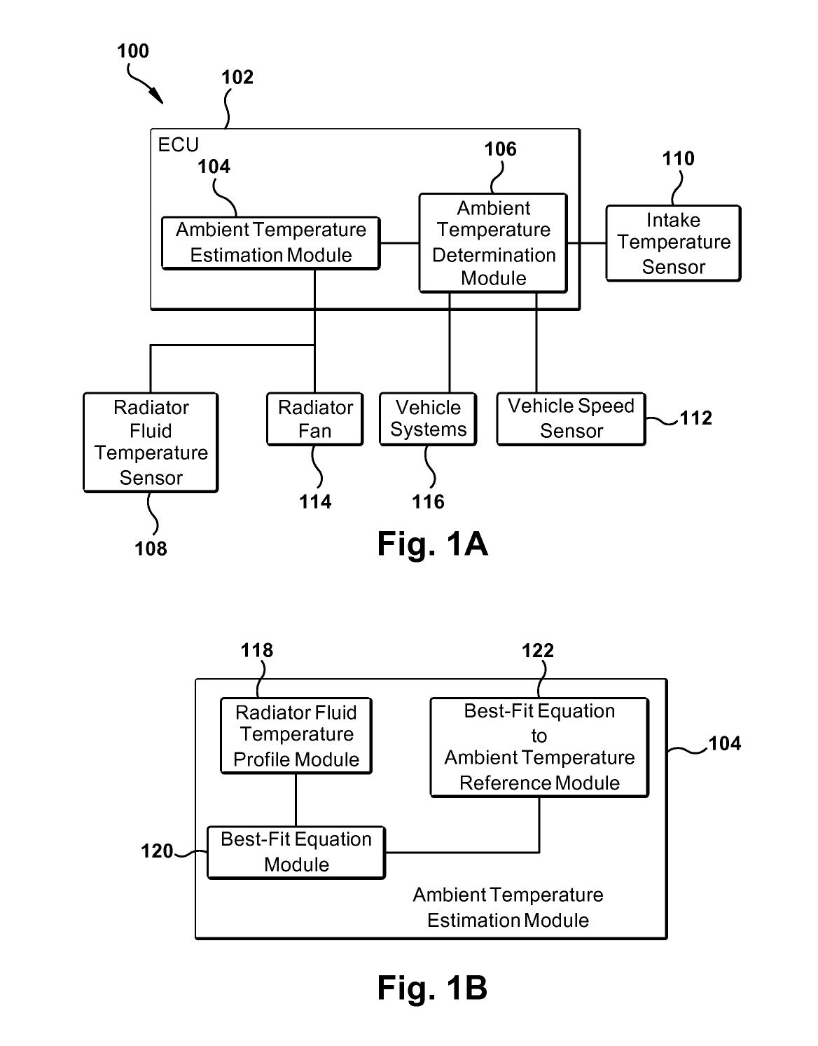

FIG. 1A illustrates a vehicular ambient temperature determination system 100 (hereinafter, “system 100”), which is a vehicle-implemented system for determining an ambient temperature. More particularly, the system 100 is implemented via a vehicle electronic control unit 102 (hereinafter, “ECU 102”) provided with an ambient temperature estimation module 104 and an ambient temperature determination module 106. The system 100 further includes a radiator fluid temperature sensor 108, an intake temperature sensor 110, and a vehicle speed sensor 112. As will be described in further detail below, the system 100 and the ECU 102 are also in communication with a radiator fan and a controller for the radiator fan 114 (hereinafter collectively referenced as “radiator fan 114”), and the ECU 102 is in communication with, and controls, various ambient-temperature-dependent vehicle systems 116.

The ECU 102 is a controller for various electronically implemented vehicle systems, and may take the form of any control unit configured to control the various ambient-temperature-dependent vehicle systems 116. For example, the ECU 102 may be a processor which executes software implemented functions to control operation of the associated vehicle. As described herein, the ECU 102 includes the ambient temperature estimation module 104 and the ambient temperature determination module 106, which cooperate to determine an ambient temperature T. Though the ambient temperature estimation module 104 and the ambient temperature determination module 106 are illustrated as being incorporated within the ECU 102, it is to be appreciated that the ambient temperature estimation module 104 and the ambient temperature determination module 106 may be components provided externally from, and in communication with, the ECU 102. Furthermore, insofar as the ECU 102 is depicted as a singular processor or controller, it is to be appreciated that the ECU 102 may be composed of several processors or controllers.

Further still, it is also to be appreciated that the ECU 102 may include various other modules or components configured to perform other vehicle control related functions. Insofar as the instant disclosure is directed to ambient temperature determination and estimation, the ECU 102 is only described with reference to the associated structure and functionality. The disclosure herein is not intended to limit the ECU 102 to such functionality. Other than the herein described structure and functionality related to ambient temperature estimation and determination, the ECU 102 is considered to be a component which is generally known in the art, and will therefore not be described in further detail.

With continuing reference to FIG. 1A, the ECU 102 is in communication with various vehicle components and systems. Particularly, the ECU 102 is in communication with the radiator fluid temperature sensor 108, the intake temperature sensor 110, the vehicle speed sensor 112, the radiator fan 114, and the ambient-temperature-dependent vehicle systems 116. With regard to the herein described system 100, the ECU 102 receives inputs from the radiator fluid temperature sensor 108, the intake temperature sensor 110, the vehicle speed sensor 112, and the radiator fan 114. The ambient temperature estimation module 104 and the ambient temperature determination module 106 operate to estimate and determine the ambient temperature T based on inputs from these vehicular components. Once the ambient temperature is estimated and determined, the ECU 102 controls the ambient-temperature-dependent vehicle systems 116 based on the estimated/determined ambient temperature T.

With reference to the input-providing components of the system 100, the radiator fluid temperature sensor 108 is provided to measure a temperature of radiator fluid in a vehicle radiator, and to communicate the measured radiator fluid temperature to the ECU 102. The radiator fluid temperature sensor 108 may be provided in and/or around the vehicle radiator, and may include one or more liquid or fluid temperature sensing devices. The radiator fluid temperature sensor 108 may take the form of any device capable of measuring a liquid or fluid temperature. It is noted that the radiator fluid may be water or any other type of suitable radiator fluid. It is further noted that the radiator fluid temperature sensor 108 is depicted as directly communicating with the ambient temperature estimation module 104. Though a direct communication link is illustrated, it is to be appreciated that the radiator fluid temperature sensor 108 may communicate with the ECU 102, which may then provide the measured radiator fluid temperature values to the ambient temperature estimation module 104.

The intake temperature sensor 110 is provided to measure an air temperature within a vehicle air intake. The intake temperature sensor 110 may be provided in the vehicle engine's air intake, or any other vehicle air intake. The intake temperature sensor 110 may include one or more air temperature measuring devices, and may the take the form of any device capable of measuring an air temperature. With respect to the vehicle air intake in which the intake temperature sensor 110 may be provided, it is noted that vehicle air intakes generally define a channel for communication of “ram” air to the vehicle. As such, air flow through the vehicle air intake is dependent upon vehicle speed. It is noted that the intake temperature sensor 110 is depicted as directly communicating with the ambient temperature determination module 106. Though a direct communication link is illustrated, it is to be appreciated that the intake temperature sensor 110 may communicate directly with the ECU 102, which may then provide the measured intake air temperature value to the ambient temperature determination module 104.

The vehicle speed sensor 112 is provided to measure a vehicle traveling speed or velocity, and may take the form of any device capable of measuring a vehicle speed. Vehicle speed sensors are considered to be generally known devices. As such, the vehicle speed sensor 112 will not be described in further detail herein. With reference to FIG. 1A, it is noted that the vehicle speed sensor 112 is illustrated as communicating directly with the ECU 102. Through this configuration, the vehicle speed sensor 112 may transmit a sensed vehicle speed Vs to the ECU 102, which then communicates the sensed vehicle speed Vs to the ambient temperature determination module 106. Alternatively, the vehicle speed sensor 112 may communicate directly with the ambient temperature determination module 106.

The radiator fan 114 is provided with the vehicle radiator, and the controller thereof operates the fan to cool the radiator fluid within the radiator. The radiator fan 114 and associated controller can be generally known devices, and will not be discussed in further detail herein. It is noted that the radiator fan 114 is in communication with the ECU 102 and the ambient temperature estimation module 104 so as to at least communicate operational periods of the radiator fan 114, as is discussed in further detail below.

Turning to the ambient-temperature-dependent vehicle systems 116, these vehicle systems 116 are components which are controlled by the ECU 102 based, at least in part, on the ambient temperature T. Non-limiting examples of ambient-temperature-dependent vehicle systems 116 include an air conditioning compressor, which is controlled to compensate for ambient temperature, and systems which estimate fuel temperature. The ambient-temperature-dependent vehicle systems 116 are considered to be generally known, and are therefore not discussed in detail herein. Moreover, insofar as the present disclosure is not concerned with the precise manner in which the ambient-temperature-dependent vehicle systems 116 operate in view of the ambient temperature T, the ambient-temperature-dependent vehicle systems 116 are depicted as a singular unit in FIG. 1A, and the operation thereof is not discussed herein.

Turning to the ambient temperature estimation module 104 and the ambient temperature determination module 106, it is noted that both may be provided in the ECU 102, as shown in FIG. 1A, or may be provided as separate components which communicate with the ECU 102. It is further noted that though depicted as separate or isolated modules, the ambient temperature estimation module 104 and the ambient temperature determination module 106 may be combined with one another into a single module, or may be incorporated within the functionality of the ECU 102. More particularly, the ambient temperature estimation module 104 and the ambient temperature determination module 106 may take the form of one or more processors within or in communication with the ECU 102, and alternatively may be software implemented controllers provided within the ECU 102. Further structural and functional description of the ambient temperature estimation module 104 and the ambient temperature determination module 106 is provided below.

The ambient temperature estimation module 104 is configured to provide an estimated ambient temperature Te and to communicate the estimated ambient temperature Te to the ambient temperature determination module 106. The ambient temperature T may then be set to the estimated ambient temperature Te by the ambient temperature determination module 106 according to the below described system and method. As shown in FIG. 1B the ambient temperature estimation module 104 includes a radiator fluid temperature profile module 118 (hereinafter, “profile module 118”), a best-fit equation module 120, and a best-fit equation to ambient temperature reference module 122 (hereinafter, “reference module 122”). The profile module 118, the best-fit equation module 120, and the reference module 122 may be provided within the ambient temperature estimation module 104, or may be separate components in communication with the ambient temperature estimation module 104.

Generally, the profile module 118 receives radiator fluid temperature data from the radiator fluid temperature sensor 108 and creates a radiator fluid temperature profile. More particularly, the profile module 118 is configured to receive radiator fluid temperature data for periods of operation of the radiator fan 114. The best-fit equation module 120 fits a best-fit polynomial equation to the created radiator fluid temperature profile, and the reference module 122 estimates an ambient temperature based on the fitted best-fit polynomial equation from the best-fit equation module 120 by referencing a preset equation-to-ambient temperature relationship. The ambient temperature estimation module 104 is in communication with the ambient temperature determination module 106, and communicates the estimated ambient temperature Te thereto. The operation of the components of the ambient temperature estimation module 104 is described in further detail below.

The ambient temperature determination module 106 may be provided to determine an ambient temperature based on either the estimated ambient temperature Te provided by the ambient temperature estimation module 104 or a measured ambient temperature Ts provided by the intake temperature sensor 110. Alternatively, the ambient temperature determination module 106 may only set the ambient temperature T to be the estimated ambient temperature Te. However, as noted hereinabove, the intake temperature sensor 110 may provide an accurate ambient temperature reading while the associated vehicle is in motion.

More particularly, when the intake ram air is flowing at a sufficient rate through the vehicle air intake, the temperature readings of the intake temperature sensor 110 are less susceptible to a heat soak condition. The heat soak condition is most likely to occur when a relatively low air flow rate is present through the vehicle air intake, such as when the vehicle is at a stop or is moving at a relatively low rate of speed. When the vehicle is stopped, moving at the relatively low rate of speed, or moving in a rearward or reverse direction, while the engine is running, the vehicle is in a condition herein termed an “idle condition”. When in the idle condition, the vehicle engine may elevate the air temperature within the vehicle air intake such that the temperature readings made by the intake temperature sensor 110 may be inaccurate.

Conversely, when the vehicle is moving at a sufficient rate of speed, the air flow through the vehicle air intake is less susceptible to being heated by the vehicle engine, which allows for relatively accurate ambient temperature measurement by the intake temperature sensor 110. As such, the ambient temperature determination module 106 may be configured to determine the ambient temperature T based on the measured or sensed ambient temperature Ts from the intake temperature sensor 110 when the vehicle is not in the idle condition (i.e., the vehicle is moving at a sufficiently high speed), and to determine the ambient temperature T to be the estimated ambient temperature Te provided by the ambient temperature estimation module 104 when the vehicle is in the idle condition.

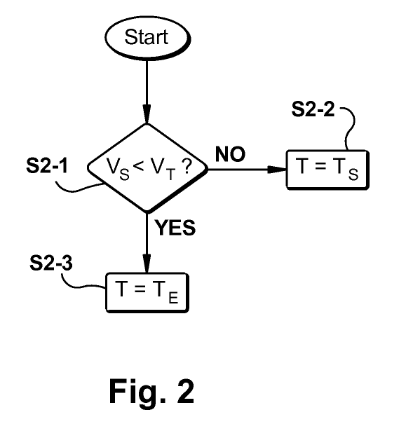

In accordance with the above-described operation of the ambient temperature determination module 106, a method for ambient temperature determination, as shown in FIG. 2, may begin with a comparison of a sensed vehicle speed Vs and a threshold vehicle speed Vt (S2-1). The vehicle speed Vs is a vehicle speed value sensed by the vehicle speed sensor 112 and communicated to the ambient temperature determination module 106 and the ECU 102. The threshold vehicle speed Vt may be set as a boundary speed demarking the vehicle idle condition from the vehicle non-idle condition. As used herein, reference to the vehicle being in the non-idle condition defines the vehicle as moving a rate of speed greater than the threshold vehicle speed Vt.

More specifically, the threshold vehicle speed Vt may be set as the vehicle speed above which the intake temperature sensor 110 is determined to be generally unaffected by heat soak. As such, if the vehicle speed Vs is less than the threshold speed Vt, the vehicle is determined to be in the idle condition, and the intake temperature sensor 110 is deemed susceptible to heat soak. Conversely, if the vehicle speed Vs is greater than the threshold speed Vt, the intake temperature sensor 110 is considered to be accurate (i.e., generally unaffected by heat soak). The threshold speed Vt may be determined in any known manner, including through experimentation, mathematical estimation, or other known methods. While the threshold speed Vt may be set to any value, exemplary values may include 0 mph, 5 mph, 10 mph, 20 mph, etc.

When the sensed vehicle speed Vs is greater than the threshold vehicle speed Vt, it may be determined that the sensed ambient temperature Ts sensed by the intake temperature sensor 110 is sufficiently accurate. As such, the ambient temperature determination module 106 may determine the ambient temperature T to be the sensed ambient temperature Ts provided by the intake temperature sensor 110 (S2-2). In this situation, the associated vehicle may be moving at a speed sufficient to ward off effects of heat soak on the intake temperature sensor 110 (i.e., a speed that provides a flow rate for the intake ram air flow sufficient to avoid the skewing affects of heat soak).

However, if the sensed vehicle speed Vs is less than the threshold vehicle speed Vt, then the intake temperature sensor 110 may be susceptible to heat soak. Particularly, in this situation, it is determined that the associated vehicle is travelling at a speed insufficient to ward off the effects of heat soak. As such, the ambient temperature determination module 106 determines the ambient temperature T to be the estimated ambient temperature Te provided by the ambient temperature estimation module 104 (S2-3). A method for ambient temperature estimation is described in further detail below.

As an alternative to the above-described method for determining whether the vehicle is in the idle condition (i.e., through comparison of a sensed vehicle speed Vs and a threshold vehicle speed Vt), changes in the sensed ambient temperature Ts from the intake temperature sensor 110 may be monitored. In such a configuration, if a change in the sensed ambient temperature Ts is greater than a predetermined value over a predetermined period of time, the change in the sensed ambient temperature Ts may be determined to be a function of heat soak, rather than a change in the ambient temperature. When such an increase in sensed ambient temperature Ts is observed, the vehicle may be determined to be in the idle condition, and the ambient temperature determination module 106 may then set the ambient temperature T to be the estimated ambient temperature Te.

Prior to describing the method for ambient temperature estimation, it is noted that the system 100 described herein may operate to only determine the ambient temperature T as the estimated ambient temperature Te regardless of the vehicle speed. Particularly, the ambient temperature determination method shown in FIG. 2 may be omitted, and the ambient temperature T may be set as equaling the estimated ambient temperature Te from the ambient temperature estimation module 104. Such a system may allow for the removal of the intake temperature sensor 110 from the vehicle air intake. Furthermore, in a system wherein the ambient temperature T is always determined to be the estimated ambient temperature Te, the ambient temperature determination module 106 may also be removed.

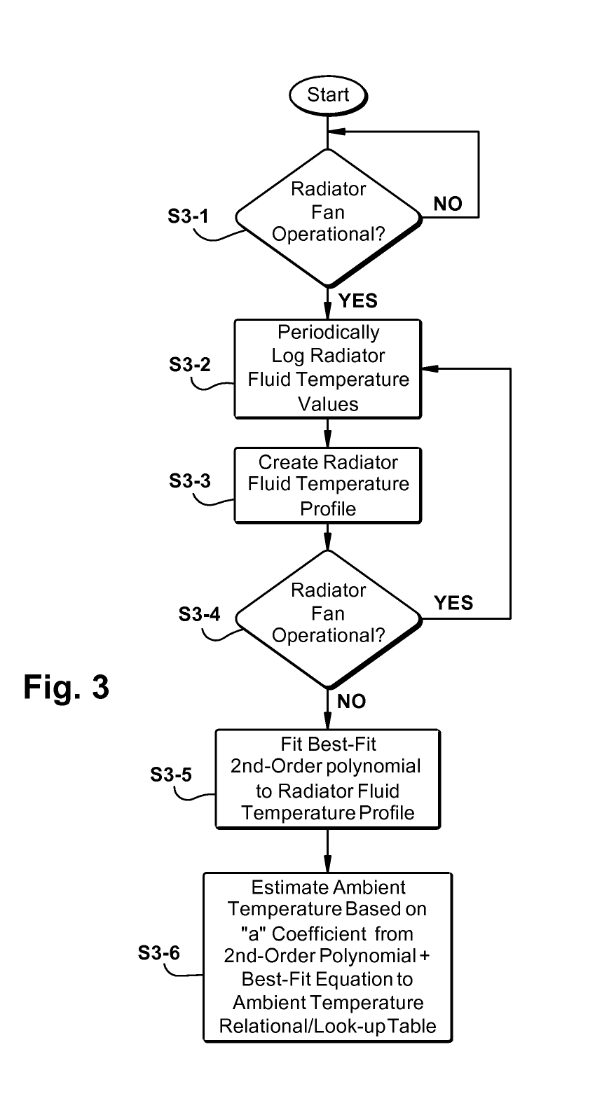

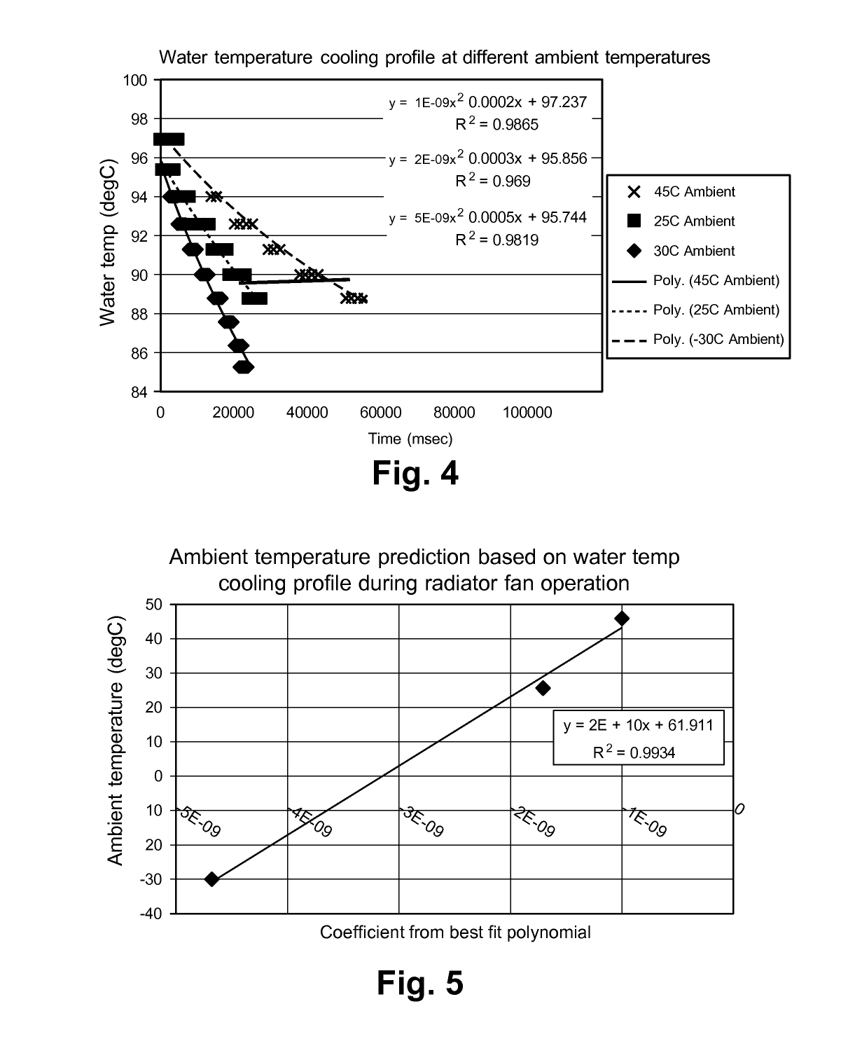

FIG. 3 is a flow-chart illustrating a method for ambient temperature estimation. As shown, the method begins with a detection of radiator fan operation (S3-1). As illustrated in FIG. 1A, the radiator fan 114 and the radiator fluid temperature sensor 108 are both in communication with the ECU 102 and the ambient temperature estimation module 104. Accordingly, detection of start and stop of the radiator fan operation may be made by the ECU 102 and/or the ambient temperature estimation module 104. Upon detection of operation of the radiator fan 114, the profile module 118 within the ambient temperature estimation module 104 begins periodically logging radiator fluid temperature values as sensed and communicated by the radiator fluid temperature sensor 108 (S3-2). The profile module 118 logs the radiator fluid temperature values and creates a radiator fluid temperature profile (S3-3), an example of which is shown in FIG. 4.

The radiator fluid temperature profile, as exemplified in FIG. 4, is a graph or data set of radiator fluid temperature values over time while the radiator fan 114 is operational. At a time t=0, the radiator fan 114 has just begun operation and the radiator fluid temperature as sensed by the radiator fluid temperature sensor 108 is at a maximum value for the subject time period (beginning at the commencement of radiator fan 114 operation). As time elapses, the radiator fan 114 cools the radiator fluid, and the radiator fluid temperature drops. The profile module 118 ceases logging radiator fluid temperature values once the radiator fan 114 ceases operation.

During periods of the radiator fan 114 operation, the profile module 118 periodically logs the radiator fluid temperature to create the radiator fluid temperature profile. The estimation of the ambient temperature according to the herein described method is generally based on the principle that the radiator fluid temperature profile (i.e., cooling profile) is predictably dependent upon and/or influenced by the ambient temperature. To further illustrate this point, FIG. 4 shows exemplary radiator fluid temperature profiles for different ambient temperatures.

The profile module 118 within the ambient temperature determination module 104 continues to log radiator fluid temperatures and to create the radiator fluid temperature profile until the radiator fan 114 ceases operation (S3-4). Once the radiator fan 114 ceases operation, the created radiator fluid temperature profile may be used for ambient temperature estimation. Three exemplary radiator fluid temperature profiles are shown in FIG. 4; one in which the ambient temperature is 45 C, another in which the ambient temperature is 25 C, and the third in which the ambient temperature is −30 C. As can be appreciated with reference to the three radiator fluid temperature profiles shown in FIG. 4, radiator fluid cooling is influenced by the ambient temperature such that as the ambient temperature increases, the radiator fluid cooling slows.

Once the radiator fluid temperature profile is created by the profile module 118, the best-fit equation module 120 fits a best-fit polynomial equation to the created radiator fluid temperature profile (S3-5). As described herein, the best-fit polynomial equation is a second-order polynomial equation, though it is to be appreciated that polynomial equations of other orders may be used (i.e., the polynomial equation may be of a first order, a third order, etc.). The herein described second-order polynomial equation takes the form of:

y=ax²−bx+c.

In this equation, y=radiator fluid temperature and x=time in msec.

As further shown in FIG. 4, the radiator fluid temperature profiles may be used to determine the above coefficients a, b, and c. In the exemplary radiator fluid temperature profiles of FIG. 4, the a, b, and c coefficients have been determined as:

| | 45 C. | 25 C. | −30 C. |
|---|---|---|---|
| “a” | 1E−9 | 2E−9 | 5E−9 |
| “b” | 0.0002 | 0.0003 | 0.0005 |
| “c” | 97.237 | 95.856 | 95.744 |

Determination of the above coefficients for the second-order polynomial is accomplished according to known methods for fitting a best-fit polynomial equation to a data set or graph. Once the best-fit second-order polynomial equation is fitted to a radiator fluid temperature profile for a given ambient temperature, the radiator fluid temperature may be determined for any time point following commencement of operation of the radiator fan 114. Alternatively stated, the determined second-order polynomial coefficients are functions of the ambient temperature. As such, once the coefficients are known, the ambient temperature T may be estimated and determined.

FIG. 5 shows an exemplary graph relating ambient temperature to the “a” coefficient from the best-fit second-order polynomial equation. The relationship shown in the graph of FIG. 5 is a predetermined or preset relation which may be experimentally determined or mathematically estimated for any vehicle configuration. In this regard, the relationship between the ambient temperature T and the “a” coefficient may generally be fixed for any given vehicle engine and radiator configuration. As such, the “a” coefficient to ambient temperature relation shown in FIG. 5 may be determined once for each vehicle and saved in a memory thereof (e.g., in the reference module 122). A similar relationship may be determined for the “b” and “c” coefficients (and/or any other coefficients when a third-order or higher polynomial equation is used).

Accordingly, once the best-fit polynomial equation is fitted to the created radiator fluid temperature profile, the estimated ambient temperature Te can be estimated using the relationship shown in FIG. 5 (S3-6). For example, if the radiator fluid temperature profile generated by the profile module 118 is fitted to a best-fit second-order polynomial equation having the “a” coefficient of 1E-09 by the best-fit equation module 120, the estimated ambient temperature Te can be determined to be 45 C by the reference module 122 according to the relation shown in FIG. 5 (which is stored in the reference module 122).

It is noted that the graphical depiction in FIG. 5 is provided to facilitate the understanding of the herein described method. The reference module 122 of the ambient temperature estimation module 104 may include a reference or look-up table wherein various estimated ambient temperatures are correlated to various potential “a” coefficient values from the best-fit second-order polynomial equations. Relatedly, the reference module 122 may store an equation relating the “a” coefficient and the estimated ambient temperature Te so as to calculate the estimated ambient temperature Te based on the determined/fitted “a” coefficient. As shown in FIG. 5, the estimated ambient temperature and “a” coefficient have a generally linear relationship, though this need not be the case if the radiator fluid temperature to time relationship is best-fitted to a third-order or higher polynomial equation.

Accordingly, the estimated ambient temperature Te is determined by the reference module 122 in view of the radiator fluid temperature profile created by the profile module 118, the “a” coefficient of the best-fit second-order polynomial equation fitted by the best-fit equation module 120, and the “a”-coefficient to ambient temperature relation stored in the reference module 122. The estimated ambient temperature Te is then communicated from the ambient temperature estimation module 104 to the ambient temperature determination module 106, where the ambient temperature T may be set as the estimated ambient temperature Te. The ECU 102 then controls the ambient temperature dependent vehicle systems 116 based on the estimated ambient temperature Te.

It is reiterated that the ambient temperature determination module 106 may be configured to only set or determine the ambient temperature T as the estimated ambient temperature Te. Alternatively, the ambient temperature determination module 106 may operate in accordance with the algorithm shown in FIG. 2 so as to determine the ambient temperature T to be the estimated ambient temperature Te only when the vehicle speed Vs is less than the threshold vehicle speed Vt. In the configuration according to FIG. 2, the ambient temperature T is set to the sensed ambient temperature Ts from the intake temperature sensor 110 when the vehicle speed Vs is greater than the threshold vehicle speed Vt.

It is also noted that the radiator fluid may be water or any other fluid suitable for use by the vehicle radiator. Furthermore, as noted above, the ambient temperature may be determined by the system 100 based on both the measured ambient temperature Ts and the estimated ambient temperature Te, or based on the estimated ambient temperature Te alone. It is further noted that insofar as the above system 100 components are described as being separate components or operating as individual elements, the components may be combined or further separated as desired.

It is also to be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A vehicle-implemented method for estimating an ambient temperature, comprising:
creating a radiator fluid temperature profile for periods of radiator fan operation; and
estimating the ambient temperature based on the created radiator fluid temperature profile.

2. The method according to claim 1, wherein creating the radiator fluid temperature profile comprises monitoring and logging radiator fluid temperature during periods of radiator fan operation.

3. The method according to claim 1, further comprising:
fitting a best-fit polynomial equation to the created radiator fluid temperature profile; and
estimating the ambient temperature based on a value of a coefficient from the fitted best-fit polynomial equation.

4. The method according to claim 3, wherein estimating the ambient temperature comprises referencing a coefficient-to-ambient temperature look-up table.

5. The method according to claim 3, wherein estimating the ambient temperature comprises calculating the ambient temperature based on a coefficient-to-ambient temperature relational equation.

6. The method according to claim 3, wherein fitting the best-fit polynomial equation to the created radiator fluid temperature profile includes fitting a best-fit second-order polynomial equation to the created radiator fluid temperature profile, and the ambient temperature is estimated based on an “a” coefficient from the fitted second-order polynomial equation.

7. The method according to claim 6, wherein estimating the ambient temperature comprises referencing an “a”-coefficient-to-ambient temperature look-up table.

8. The method according to claim 6, wherein estimating the ambient temperature comprises calculating the ambient temperature based on an “a”-coefficient-to-ambient temperature relational equation.

9. A vehicle-implemented method for determining an ambient temperature, comprising:
determining whether a vehicle is in an idle condition;
setting the ambient temperature as a sensed ambient temperature from temperature sensors provided in a vehicle air intake when the vehicle is not in the idle condition; and
setting the ambient temperature as an estimated ambient temperature estimated based on a radiator fluid temperature profile when the vehicle is in the idle condition.

10. The method according to claim 9, wherein determining whether the vehicle is in the idle condition further comprises:
detecting a vehicle speed;
comparing the detected vehicle speed to a threshold vehicle speed; and
determining that the vehicle is in the idle condition if the detected vehicle speed is less than the threshold vehicle speed.

11. The method according to claim 9, wherein determining whether the vehicle is in the idle condition further comprises:
detecting whether a predetermined increase of the sensed ambient temperature from the temperature sensors provided in the vehicle air intake occurs over a predetermined period of time;
determining that the vehicle is in the idle condition when the increase in the sensed ambient temperature is greater than the predetermined increase over the predetermined period of time.

12. The method according to claim 9, wherein setting the ambient temperature as the estimated ambient temperature estimated based on a radiator fluid temperature profile when the vehicle is in the idle condition further comprises:
creating the radiator fluid temperature profile by monitoring and logging radiator fluid temperature during periods of radiator fan operation;
fitting a best-fit polynomial equation to the created radiator fluid temperature profile; and
estimating the ambient temperature based on a value of a coefficient from the fitted best-fit polynomial equation.

13. The method according to claim 12, wherein fitting the best-fit polynomial equation to the created radiator fluid temperature profile includes fitting a second-order polynomial equation to the created radiator fluid temperature profile, and the ambient temperature is estimated based on an “a” coefficient from the fitted second-order polynomial equation.

14. The method according to claim 13, wherein estimating the ambient temperature comprises referencing an “a”-coefficient-to-ambient temperature look-up table.

15. The method according to claim 13, wherein estimating the ambient temperature comprises calculating the ambient temperature based on an “a”-coefficient-to-ambient temperature relational equation.

16. A vehicular ambient temperature determination system, comprising:
an ambient temperature estimation module configured to create a radiator fluid temperature profile based on sensed values of radiator fluid temperature during periods of radiator fan operation and to estimate an ambient temperature based on the radiator fluid temperature profile.

17. The system according to claim 16, wherein the ambient temperature estimation module further comprises:
a radiator fluid temperature profile module configured to monitor and log sensed radiator fluid temperature during periods of radiator fan operation;
a best-fit equation module configured to fit a best-fit polynomial equation to the radiator fluid temperature profile created by the radiator fluid temperature profile module; and
a best-fit equation to ambient temperature relational module configured to estimate the ambient temperature by relating a value of a coefficient of the best-fit polynomial equation fitted by the best-fit equation module to an associated ambient temperature.

18. The system according to claim 17, wherein the best-fit equation to ambient temperature relational module comprises one of: a look-up table relating coefficient values to ambient temperatures and an “a”-coefficient-to-ambient temperature relational equation.

19. The system according to claim 16, further comprising:
a temperature sensor provided in a vehicle air intake; and
an ambient temperature determination module in communication with the temperature sensor and the ambient temperature estimation module,
wherein the ambient temperature determination module is configured to detect whether an associated vehicle is in an idle condition, and to determine the ambient temperature to be a temperature sensed by the temperature sensor when the vehicle is not in the idle condition and to be the estimated ambient temperature estimated by the ambient temperature estimation module when the vehicle is in the idle condition.

20. The system according to claim 19, further comprising:
a vehicle speed sensor configured to sense a vehicle speed,
wherein the ambient temperature determination module detects the vehicle to be in the idle condition when the sensed vehicle speed is less than a threshold vehicle speed.
